(19) United States
(12) Patent Application Publication
(10) Pub. No.: US 2008/0256825 A1
(43) Pub. Date: Oct. 23, 2008

(54) Hand dryer with visible light indicated sensing area

(75) Inventor: Chi-Chin Hsu, Taipei County (TW)

Correspondence Address: Joe McKinney Muncy, PO Box 1364, Fairfax, VA, 22038-1364, US

(73) Assignee: Hokwang Industries Co., Ltd.

(21) Appl. No.: 11/785,371

(22) Filed: Apr. 17, 2007

(51) Int. Cl. F26B 19/00

(52) U.S. Cl. 34/529; 34/89

(57) ABSTRACT

A hand dryer with visible light indicated sensing area utilizes a visible light to provide the user a visible indicating area that can be recognized by the naked eyes, so that the user can identify the invisible IR sensing area through the visible indicating area and conveniently put the hands in the sensing area for drying.

### FIELD OF THE INVENTION

The present invention is related to a hand dryer, and more particularly to a hand dryer, which employs a visible light to indicate an invisible IR sensing area.

### BACKGROUND OF THE INVENTION

Generally, in the hotels, restaurants or shopping malls, people only can air dry their hands after washing if lacking of tissues or handkerchief. Accordingly, a “hand dryer” is produced for providing the user a convenient way to dry the hands, for example, R.O.C. Patent Publication No. 72462 disclosed a multi-purpose hand dryer, which includes a filter device configured by a filter connected to a movable gate and sponge for receiving various aromatics, a driving control switch configured by a selecting switch, which is used for adjusting a start switch extended from an external power source, and a timer, wherein the selecting switch provides three buttons of close, hot air and cold air and can have a long term operation, and the timer can control the operation time, a blower mounted outside a surrounding frame of isolation plate, a heating wire mounted at the blowing entrance, and an air directing device configured by plural isolating plates, thereby the blower can be driven by a driving device for outputting cold and hot air so as to provide the functions of hand and hair drying.

However, for the user, a hand dryer as described above, which must be controlled by the driving control switch, is inconvenient especially as the user's hands are wet. Therefore, another kind of hand dryer which employs IR (infrared ray) sensing is generated. R.O.C. Patent Publication No. 309748 disclosed a hand dryer with UV sterilization function, which is configured by a base structure including a base, a power indicator, an IR sensor, an IR controller, a blower, a heating coil, and an UV light, and a housing structure including a housing, a power indicating window, a blowing entrance, a sensing window and an UV ray reflecting net. The UV light is stabilized on the base by a set of lamp holders, so that when the base and the housing are assembled together, the UV light is located at the inner upper side of the UV ray reflecting net, which is positioned at the blowing entrance, and the UV light is tuned on cooperating with the external power source for sterilizing the inside of the hand dryer. The blower is configured by two symmetrical blower housings, a motor, a sleeve, and a fan, and is fixed on the base of the hand dryer, wherein the motor is screwed at the center of the inner wall of blower housings, the sleeve is sleeved on the motor and screwed on the axle center of the motor, the fan is tightly sleeved on the sleeve so as to form an integrated turning body with the motor, and the motor further has a set of electric wires connecting to the IR controller for being driven by the IR controller, thereby forming a novel blower structure which can reduced the space inside the hand dryer so as to maximize the sterilization capability of UV light. The IR controller is a rectangular circuit board with various electronic components mounted thereon and has five sets of terminals respectively connecting to the external power source, the power source indicator, the IR sensor, the motor and the heating coil. The IR sensor is directly fixed by the holder on the base and is connected to the power source, so that the sensing signal form the IR sensor can control the power-on and off of the motor and the heating coil, and besides, the IR sensor also can be the light of the power indicator for indicating the stand-by condition of the hand dryer. The UV ray reflecting net is formed by stainless steel with light reflection capability and is fixed at the blowing entrance under the housing, so that when the housing is assembled with the base, the UV ray reflecting net will be located under the UV light, thereby reflecting the UV wave and enhancing the sterilization efficiency.

Although the IR sensing device described above (namely, the IR sensor) radiates infrared rays to user's hands and receives the reflected infrared rays by IR receiver for triggering the hand dryer to output hot air, the user might need to make a random movement for finding the IR sensing area since the infrared rays are invisible, which is very inconvenient. In addition, even the hand dryer is actuated, it still might shut down if the user's hands moves out of the sensing area owing to rubbing or turning, and only when the user's hands go back into the sensing area, the hand dryer can output hot air again. Obviously, this is quite inconvenient for the user, and further, the energy will be wasted due to the repeated power-on and off, which also might reduce the life time of the hand dryer. Therefore, an improvement for the hand dryer is needed.

### SUMMARY OF THE INVENTION

The object of the present invention is to provide the user a visible indicating area that can be recognized by the naked eyes, so that the user can identify the invisible IR sensing area through the visible indicating area and conveniently put the hands in the sensing area for drying.

For achieving the object described above, the present invention provides a hand dryer with visible light indicated sensing area includes a hand dryer, for heating an air after acquiring a sensing signal and output the heated air through a blowing entrance; an IR (infrared ray) sensing device, for outputting an infrared ray through an IR radiator and deciding the output of the sensing signal after an IR receiver detects the infrared ray in a sensing area thereof; and a visible light indicating device, for outputting a visible light to form an indicating area after acquiring the sensing signal from the IR sensing device so as to inform an user the invisible sensing area, thereby facilitating the user to locate the hands in the sensing area for drying.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional schematic view showing a preferred embodiment of the present invention;

FIG. 2 is a structural schematic view showing an IR (infrared ray) sensing device and a visible light indicating device in a preferred embodiment according to the present invention;

FIG. 3 is a schematic view showing the sensing situation in a preferred embodiment according to the present invention; and

FIG. 4 is another schematic view showing the sensing situation in a preferred embodiment according to the present invention.

### DESCRIPTION OF THE PREFERRED EMBODIMENT

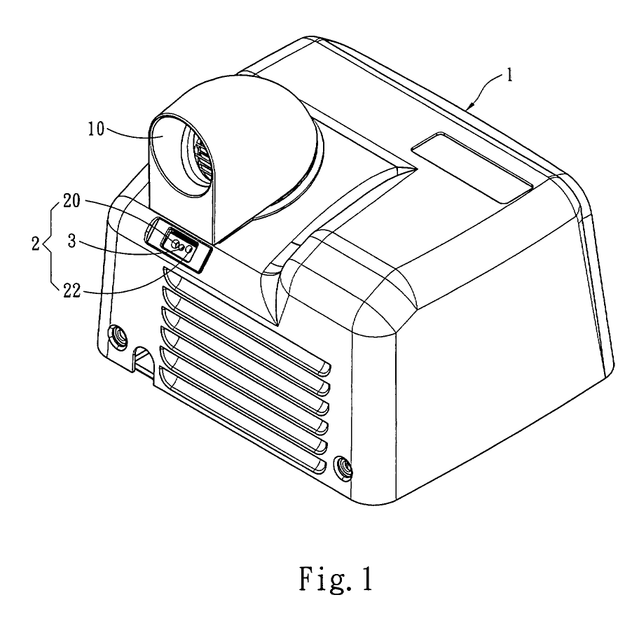

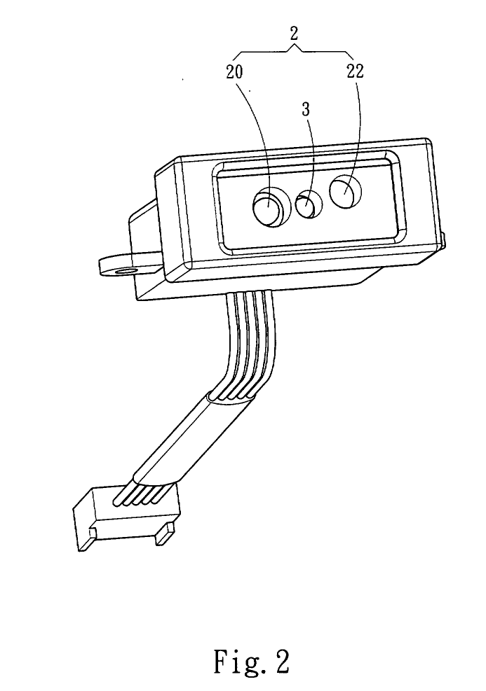

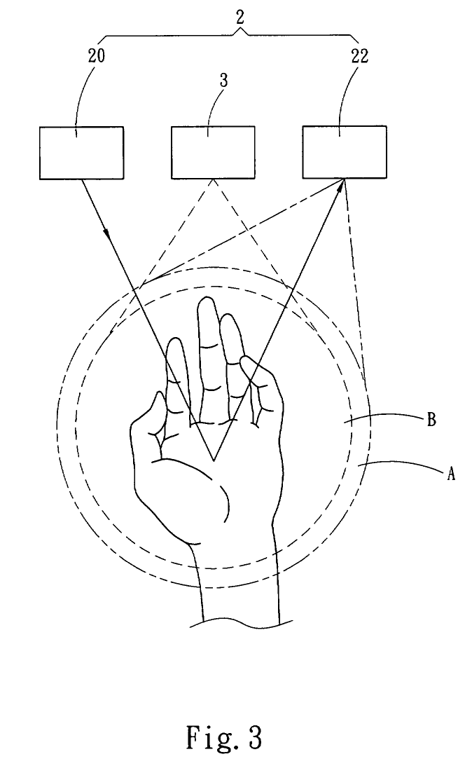

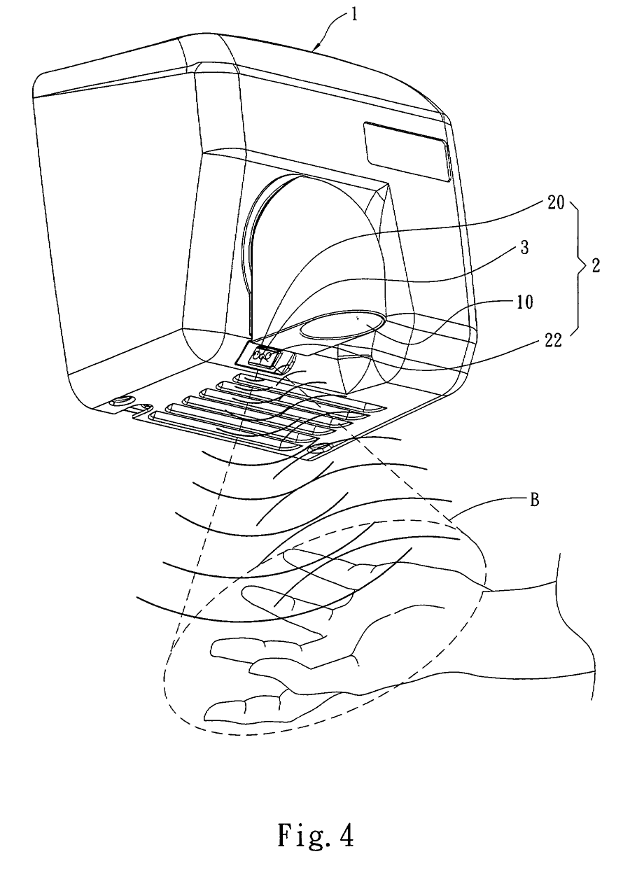

Please refer to FIGS. 1 to 4, which are respectively a three-dimensional schematic view showing a preferred embodiment of the present invention, a structural schematic view showing an IR (infrared ray) sensing device and a visible light indicating device, a schematic view showing the sensing, and another schematic view showing the sensing. As shown, the present invention provides a hand dryer with a visible light indicated sensing area, includes:

a hand dryer 1, which will heat the air after acquiring a sensing signal and then output the heated air through a blowing entrance 10, wherein the structure of the hand dryer 1 is a known technology, which will not be described further, for example, the structure of the hand dryer 1 can be referenced R.O.C. Patent Publication No. 309748, in which an UV light for sterilization is included;

an IR (infrared ray) sensing device 2, which will output infrared ray through an IR radiator and can decide an output sensing signal through detecting the infrared ray in a sensing area A by an IR receiver 22, wherein the IR receiver 22, in the sensing area A, detects the infrared ray, which is outputted from the IR radiator 20 and reflected by user's hand, and then transmits the sensing signal after receiving the reflected infrared ray, preferably, the IR radiator can be an LED, and the IR receiver can be an IR mirror sensor; and

a visible light indicating device 3, which will output a visible light after acquiring the sensing signal from the IR sensing device 2 so as to form an indicating area B, wherein the indicating area B is almost identical to the sensing area A, so that the user can easily recognize the sensing area A, which actually can not be identified by naked eyes, through the visible indicating area B, and thus, for being sensed by the IR sensing device 2, the user only has to conveniently put the hands in the indicating area B, and then the hand dryer 1 can be driven, preferably, the visible light indicating device 3 can be a LED. Here, the indicating area B is slightly smaller than the sensing area A, so that the user's hands can be centralized in the sensing area A, so as to prevent the hands from departure as rubbing or turning.

As operating, firstly, the user puts the hands in the sensing area A, so that the IR receiver 22 can detect the reflected infrared ray from the IR radiator 20, and then the IR receiver 22 outputs the sensing signal to the visible light indicating device 3 and hand dryer 1, so that the user can see the visible light projected by the visible light indicating device 3 (preferably a visible light with a particular color that can be easily identified by the user, such as red, blue, orange, green etc.) and realize that if the hands are located in the sensing area A since the hands will be projected by the indicating area B with the color of visible light, so as to prevent a blindly searching.

In the aforesaid, because the present invention utilizes a visible light indicating device 3 to form a visible light indicating area B so as to guide the user the position of the invisible sensing area A of the IR sensing device 2, the user can conveniently put the hands in the indicating area B for drying so as to prevent the hands from blind moving, which is caused from the invisible sensing area of IR sensing device, and also effectively avoid the hands from departing from the sensing area of the IR receiver 22 as rubbing or turning, which might cause the dryer 1 to stop the hot air output. Then, a repeated start and stop of the dryer 1 in a short term caused from the hands exceeding the sensing area can be prevented so that not only the energy can be saved but the hand dryer 1 can have a longer life time.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hand dryer with visible light indicated sensing area, comprising:
a hand dryer, for heating an air after acquiring a sensing signal and output the heated air through a blowing entrance;
an IR (infrared ray) sensing device, for outputting an infrared ray through an IR radiator and deciding the output of the sensing signal after an IR receiver detects the infrared ray in a sensing area thereof, and
a visible light indicating device, for outputting a visible light to form an indicating area after acquiring the sensing signal from the IR sensing device so as to inform a user the invisible sensing area, thereby facilitating the user to locate the hands in the sensing area for drying.

2. The hand dryer as claimed in claim 1, wherein the visible light indicating device is an LED (light emitting diode).

3. The hand dryer as claimed in claim 1, wherein the IR radiator is an LED (light emitting diode).

4. The hand dryer as claimed in claim 1, wherein the IR receiver is an IR mirror sensor.

5. The hand dryer as claimed in claim 1, wherein the indicating area is smaller than the sensing area of the IR receiver.
